(19) United States
(12) Patent Application Publication
(10) Pub. No.: US 2003/0234855 A1
(43) Pub. Date: Dec. 25, 2003

(54) Image width correction for led printhead

(75) Inventor: Yee S. Ng, Fairport, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/174,801

(22) Filed: Jun. 19, 2002

(51) Int. Cl. B41J 2/45

(52) U.S. Cl. 347/238

(57) ABSTRACT

A method and apparatus for correcting pixel inaccuracies in a writing device having a linear array elements wherein a mechanism to control temperature within a predetermined portion of the writing device is used to correct placement inaccuracies by first determining the inaccuracies with respect to a reference point and then adjusting the temperature within the predetermined portion of the writing device.

### FIELD OF THE INVENTION

The present invention is related to correction of pixel inaccuracy, and more particularly, to correction for pixel inaccuracies in array writers.

### BACKGROUND OF THE INVENTION

The prior art has numerous references that disclose array writers, such as marking engines that are used in printers and copiers. Among these array writers are LED writers that are typically arranged as a single linear array or as multiple linear arrays. LED arrays will generally have some inaccuracies in pixel placement. There are various sources for the inaccuracy in pixel placement such as inherent manufacturing tolerance of the LED array or variability within the lens array that is used with the LED array, each of which can result in image placement distortion. The LED array will form an image on a receiver that moves in a direction referred to as the in-track direction and the inaccuracies in the in-track direction are referred to as bow. The in-track direction is perpendicular to the line in which linear arrays are formed, referred to herein as the cross-track direction. Inaccuracies in the cross track direction are referred to as length precision and are measured in terms of deviations from the nominal length of the LED array. The LED elements as arranged can exhibit inaccuracies in both the in-track and the cross-track directions.

Tandem writers are typically used for color printing, with each writer being responsible for a different color. Inaccuracy in pixel placement causes registration errors between the writers. These placement errors commonly result in color-to-color registration errors. Some of the pixel placement errors are caused by the mechanical placement error in the LED printhead assembly process; others are caused by lens variability and distortion on the images. The lens arrays as referred to herein are of the type, or similar to, SELFOC® (a trademark of Nippon Sheet Glass Company, LTD) lens. Improvements have been made in the mechanical placement of LED arrays that are used in LED printhead substrates. The sorting of lens alleviates a major distortion problem, however, the sorting procedures are time consuming. Mechanical adjustments of the lens also provides a solution to distortion problems by compensating for image distortion using mechanical adjustment mechanisms such as using screws in the lens mount as discussed in U.S. Pat. No. 5,973,718; 1999 entitled “Method and Apparatus to Correct for Active Write Length and Bow Changes in LED print bars”, issued to Charnitski, et al. (Charnitski). Charnitski provides a degree of correction, however, the amount of correct is limited. Additionally, matching a lens to a printhead has been found to provide a reduction in color-to-color registration errors in Tandem machine. Typically, these prior art methods can reduce the bow error ˜30 to 40 μm in an A3 size printhead but are still a time consuming process. Electronic bow correction has been discussed in prior art disclosures such as U.S. Pat. No. 5,585,836 entitled “Electrophotographic Image Recording Apparatus and Method with Correction for Bow in Placement of Recording Elements”, issued to Pham, et al. in 1996. U.S. patent application Ser. No. 09/870,305 (commonly assigned with the present invention) entitled “Course and Fine Electronic Bow Correction for a Writer” in the name of O'Hara, et al., filed in May 2001, corrects pixel placement error in the in-track direction with a potential accuracy of better than 5-10 μm. However electronic bow correction only takes into account misplacement of pixel elements in the in track direction, and provides no assistance for the errors that exist in the pixel placement in the cross-track direction. Similar amounts of error can be seen in the cross-track direction of the image as well. Without excessive sorting, that results in a reduction in yield and increases cost significantly, alternative methods are needed to further improve the process.

From the foregoing discussion, it should be readily apparent that there remains a need within the art for an apparatus and process that provides for correction in array writers in a cross track direction without requiring the sorting of pieces used to make up the array writers.

### SUMMARY OF THE INVENTION

The present invention addresses the aforementioned shortcomings within the prior art and corrects the inaccuracies in pixel placement in the cross track direction by intentionally distorting pixel locations after the printhead has been integrated with the lens and the cross-track pixel position has been measured.

These and other objects of the invention are provided by the two embodiments of the invention. The first embodiments uses an LED printhead having a substrate (ceramic or other substrate) attached to a thermal electric cooler via the heatsink. The temperature on the substrate can be raised or lowered, to increase or decrease the linear dimensions of the printhead to compensate for the pixel placement error in the cross track direction. Radiometric data of the pixels (with the lens) is calibrated so that uniformity correction can be performed with the whole system. The second method assumes that there is a thermal electric cooling device attached to the SELFOC® Lens mount, so the lens can be stretched or contracted thermally to compensate for errors in the cross track direction of LED printhead from the determined nominal length. Radiometric data is taken and uniformity correction performed. The above method can be combined with the electronic bow correction of the in track direction to yield much better total pixel placement accuracy in both the cross track and in track directions and increase manufacturing yield with little sorting.

### BRIEF DESCRIPTION OF THE DRAWINGS

FIG. 1 is a diagram illustrating the first embodiment of the invention;

FIG. 2 is a diagram illustrating the second embodiment of the invention;

FIG. 3 is a view of a lens with a stiffening bar assembly; and

FIG. 4 is a top view of the invention.

### DETAILED DESCRIPTION OF THE INVENTION

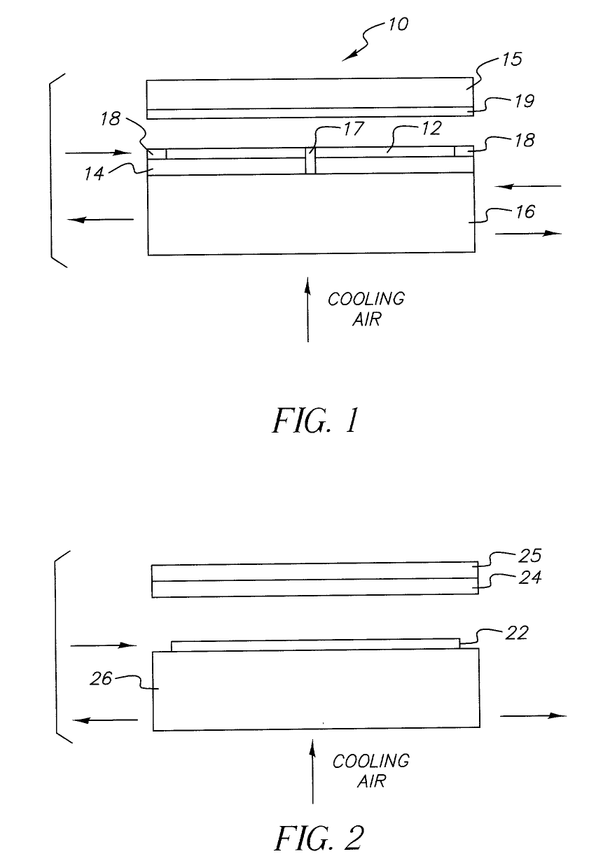

The present invention provides a method and apparatus for correcting inaccuracies in pixel placement within LED writers that can cause color-to-color registration errors in tandem machines that employ more than one writer. There are two embodiments proposed for the present invention that provide an apparatus that can accomplish intentional distorting of an LED writer in the cross track direction to compensate for inaccuracies in writer length. The first embodiment is illustrated in FIG. 1 and provides a substrate 12 (ceramic or other substrate) for the LED printhead 10 that is attached to a thermal electric cooler 14 which is in turn attached to a heatsink 16, the temperature on the substrate 12 can be raised or lowered to increase or decrease the linear dimension of the LED printhead 10 to compensate for the pixel placement error in the cross direction. The radiometric data for the pixels (with the lens) is calibrated so that uniformity correction can be performed with the whole system.

FIG. 2 illustrates the second embodiment wherein the thermal electric cooler 24 is attached to the mount of the SELFOC® Lens 25, so the lens can be stretched or contracted, controlled by the thermal electric cooler 24, to compensate for inaccuracies in the cross track direction of the LED printhead 20 from the nominal length. Then radiometric data is taken to perform uniformity correction.

In order to perform uniformity correction, for either of the embodiments illustrated in FIG. 1 or FIG. 2, radiometric data is first taken. The initial position calibration is done with the temperature of the thermal electric cooler set to a nominal operating temperature in the engine (for example, 30 C.°), and then obtaining the pixel position data. Then the thermal electric cooler temperature is adjusted to expand or contract the Writer substrate (as described in embodiment for FIG. 1 above) or distort the lens via thermal-mechanical means (as described in the embodiment for FIG. 2 above) to compensate for Writer length differences, then the radiometric data on the image plane is obtained and the exposure uniformity correction can be accomplished based on this data. The above method can be combined with the electronic bow correction in the in track direction to yield much better total pixel placement accuracy in both the in-track and cross-track directions and increase manufacturing yield without requiring significant sorting.

Referring again to FIG. 1, the first embodiment for compensation of an LED writer, assume that the writers (printhead 10 including SELFOC® Lens 15) has pixel locations determined by a standard pixel position scanning done at a predetermined temperature (preferably 30 C.°). Assuming further that the substrate (the LED arrays 13 are mounted on top of the substrate 12) of the LED printhead 10 is mounted on a series of thermal electric coolers 14 (see FIG. 1) and the thermal electric coolers are mounted on a heatsink. Further assume that heatsink 16 is cooled by conventional forced air-cooling (external air temperature can also be controlled to minimize stress). The ceramic substrate 12 and thermal electric cooler 14 have a center hole/pin 17 construction that allows the ceramic substrate 12 to expand or contract (with respect to the center pins on the heatsink) thermally. The term center hole/pin 17 as used herein can refer to either a hole, a pin, or a combination of a hole and pin. A temperature controller (not shown) can be used to raise or lower the temperature of the thermal electric cooler/printhead substrate in order to achieve expansion or contraction of the LED arrays. As a further example of the invention, employing a ceramic substrate 12 that matches the thermal expansion coefficient of the LED material (GaAs), typically, a total change of 29 μm in the LED printhead having a nominal length of about 14 inches is achievable with a temperature change of 15 C.°. The total change of 29 μm is achieved from the center hole/pin 17 construction viewpoint as illustrated in FIG. 1 by altering the temperature +/−7.5 C.° from a nominal temperature of 30 C.° resulting in change of +/−14.5 μm. This change of +/−14.5 μm is arrived at from center hole/pin 17 viewpoint by a +/−7.25 μm length change from either side of the pin with the total length change of +/−14.5 μm. This change of +/−14.5 μm can be achieved with a change in temperature that has a range of 15 C.° (+/−7.5 C.° from a nominal temperature of 30 C.°). Accordingly, a writer having errors on the order of ˜40 μm maximum in the cross-track direction can be substantially reduced by thermally expanding or contracting the LED array to match a nominal writer length after the length measurement is finished. In the foregoing example the center hole/pin 17 is envisioned to be about 1 mm in diameter. The preferred embodiment also envisions that the LED printhead 10 be constructed using one linear LED array driven by two sets of drivers, one driver for even numbered pixels and another driver for odd numbered pixels. It is also envisioned that the printhead pixel brightness will be measured at that preset compensation temperature which is the same 30 C.° temperature used during the standard pixel position scanning and uniformity correction will be done based on the radiometric measurement. The center hole/pin 17 show in FIG. 1 operates to fix the center location of the ceramic substrate upon which the LED arrays are mounted, so any thermal expansion is therefore, relative to the center location.

In the case of the second embodiment as shown in FIG. 2, the substrate 22 together with the heatsink 26 for the LED printhead 20 are mounted and cooled conventionally, however the mount for the SELFOC® Lens 25 has a separate thermal electric cooler 24 attached to it. After the pixel position measurements are done with the writer at the nominal 30 C.° temperature used during the standard pixel position scanning, the thermal electric cooler 24 can be used to raise or lower the temperature on the lens stiffening bar to effect a change in the length of the stiffening bar that is transmitted to the SELFOC® Lens 25 by mechanical and thermal forces.

FIG. 2 illustrates a substrate 22 containing the LED array on top of heatsink 26. The lower portion of the SELFOC® Lens 25 is mounted on thermal electric cooler 24. Variations in the temperature of thermal electric cooler 24 exert a lateral (cross-track) force across the entire SELFOC® Lens 25 that operates to distort lens 25 mechanically and optically. In FIG. 2 the thermal electric cooler 24 with heatsink 26 is attached to the lower portion of the lens mount which then exerts a lateral (cross-track) force across the lower portion of the lens to distort the lens mechanically and optically in the cross-track direction. Other embodiments could have the thermal electric cooler 24 attached to the upper portion of the lens mount which would then exert a lateral, cross-track force across the upper portion of the lens to mechanically and optically distort the upper portion of the lens in a cross-track direction. These distortions are intentionally created to correct for the Writer length deviation from the nominal length. There are inherent advantages in this distortion methodology in that the lens is a passive device, so the lens system is less subject to printing image load change and a smaller thermal electric cooler is typically all that is required. The lens system is unlike the LED printhead where the substrate for the LED printhead has to cool an active device—the LED emitter array. Other embodiments may choose to use a stiffener material (such as Steel) that has a higher thermal expansion coefficient than the GaAs, so a larger optical length change is achieved with a smaller change in temperature on the stiffening bar, and reduce the length error of Writers effectively.

The invention specifically envisions that a combination of the Writer optical length control (cross-track direction) with the electronic bow correction (in track direction) to achieve much better color to color registration of Writers in a high speed tandem printer with multiple Writers.

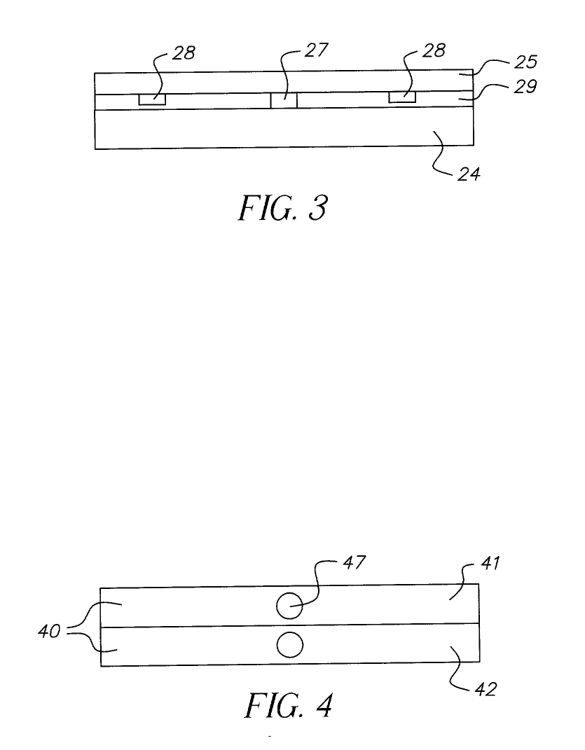

FIG. 3 illustrates the preferred stiffening bar 29 that can be used as a lens mount for the embodiment of FIG. 2. In this configuration, the thermal electric cooler 24 and the stiffening bar 29 are also set to nominal temperature for scanning. The intent of the preferred embodiment is to modulate the temperature on the lens via the stiffening bar, without modulating the temperature on the rest of the system. Therefore, it may be desirable to isolate the assembly of the thermal electric cooler mounted on the stiffening bar from the rest of the system. The embodiment illustrated in FIG. 3 has lens 25 mounted on thermal electric cooler 24, therefore, the stiffening bar 29 contains the centering locator 27 which is functionally equivalent to the center hole/pin 17 of the first embodiment. By placing the centering locator 27 on the stiffening bar 29, temperature changes in thermal electric cooler 24, result in spatial changes in thermal electric cooler 24 that are transferred as mechanical and thermal forces through thermal couplings to the lens 25 and operate to change the focus attributes of the lens 25.

Referring to FIG. 3, which is a detailed view an embodiment of the SELFOC® lens 25 with stiffening bar 29 used as a lens mount, the invention envisions using thermal couples 28 attached to the SELFOC® lens 25 and the stiffening bar 29. The thermal couples 28 are envisioned by this embodiment because the SELFOC® lens 25 is a good thermal isolator and implementing thermal couples 28 in the assembly of the stiffening bar 29 and the SELFOC® lens 25. The thermal couples 28 not only assist in the transfer of heat but also transfers the spatial changes that occur in thermal electric cooler 24 with changing temperature to the SELFOC® lens 25 as an application of mechanical forces. Here, the use of mechanical forces as applied by the invention that change the optics of the system can clearly be seen to contrast with that correction techniques as described in U.S. Pat. No. 5,973,718. U.S. Pat. No. 5,973,718 applied mechanical forces through a screw mechanism to correct bow, but also effecting a change in writer length. The invention described, herein, applies mechanical forces as a result of controlling temperature in thermal electric cooler 24 and transferring resulting spatial changes in thermal electric cooler 24 to the lens 25. The invention's intent is to either heat (or cool) the stiffening bar 29, which is preferably steel, that in turn mechanically distorts portions of the lens, thereby creating slight optical contraction (magnification) to the pixels on the image plane.

The embodiment illustrated in FIG. 1 can also employ a stiffening bar 19 as a lens mount for SELFOC® lens 15. Here, the assembly containing lens 15 and stiffening bar 19 are attached to the thermal electric cooler 14 via thermal couples 18 as shown in FIG. 1. Changes within the thermal electric cooler 14 will stress the stiffening bar 19 evenly. Thermal couplings 18 are applied to the embodiment of FIG. 1 to allow the stress in the stiffening bar 19 to be transmitted to the SELFOC® Lens through application of thermal and mechanical forces.

FIG. 4 illustrates a top view of a variation of the embodiment shown in FIG. 1. As previously stated, the embodiment in FIG. 1 envisions that the LED printhead 10 is constructed with one linear LED array driven by two sets of drivers, one for even number pixels and another for odd numbered pixels. FIG. 4 illustrates a top view having two linear LED arrays 40, a first odd pixel row 41 and a second even pixel row 42. Each of the LED arrays 40 employs center pin 47 construction techniques. The invention can be constructed using one linear array driven by one set of drivers (single-sided drivers), by one linear array using two sets of drivers (double-sided drivers), or alternatively, multiple LED arrays driven by a set of multiple drivers as shown in FIG. 4.

The invention envisions that many types of thermal couplings can be used to transport temperature variations throughout the foregoing systems of the invention. The most inexpensive implementation of a thermal coupling is to use a single stiffening bar and one thermal electric cooler. The most effective manner of thermal coupling would employ multiple stiffening bars on the lens and multiple thermal electric coolers. Other embodiments could use something akin to two stiffening bars on the lens, with the thermal electric cooler on one of the stiffening bars and a thermal coupling (such as copper braid) to thermally connect the two stiffening bars.

Once the thermal couplings in any of the above related embodiments are implemented, both thermal and mechanical forces are transmitted to the lens. The relative amount of thermal and mechanical force depends on the embodiment employed. Temperature variation is conducted to the lens as a function of thermal conductivity of the thermal couples. One function of the stiffening bar is to couple the mechanical distortion onto the lens, the other function is to transmit the temperature to the lens to make that expand.

The foregoing description describes the preferred manner of thermally inducing distortion within the lens 25 by using a stiffener that stresses the lens more uniformly (evenly) than using mechanical screws that twist the lens at one point. Other embodiments that thermally stress portions of the writer will be readily apparent to those skilled in the relevant arts. Additionally, techniques can be employed that will provide relatively uniform stress to portions of the writer, such as employing a piezoelectric material to stress the writer in a desired area to correct writer length inaccuracies.

The foregoing description details the embodiments most preferred to the inventor. Variations in the foregoing embodiments will be readily apparent to those skilled, therefore, the breadth of the invention should be measured by the appended claims.

Parts List

10 printhead

12 substrate

13 LED array

14 thermal electric cooler

15 lens

16 heatsink

17 center hole/pin

18 thermal couple

19 stiffening bar

20 printhead

22 substrate

24 thermal electric cooler

25 lens

26 heatsink

28 thermal coupling

29 stiffening bar

40 array

41 oddrow

42 even row

47 centering pin

What is claimed is:

1. A method for correcting pixel inaccuracies comprising the steps of:
providing a writing device having a plurality of writing elements formed in a first direction;
measuring placement inaccuracies within said writing elements in said first direction; and
controlling stress in a predetermined area of said writing device to reduce inaccuracies within said writing device.

2. The method of claim 1, wherein the providing step further comprises said writing device being integrated with a lens.

3. The method of claim 2, further comprising:
the providing step further comprises providing a temperature controlling device coupled to said lens; and
the controlling step further comprises altering temperature in said temperature controlling device to reduce inaccuracies within said writing device.

4. The method of claim 3, wherein the controlling step further comprises reducing inaccuracies within said writing device by application of a mechanical force to said lens.

5. The method of claim 3, wherein the providing step further comprises coupling said temperature controlling device to said lens through at least one thermally conductive coupling device.

6. The method of claim 5, wherein the providing step further comprises providing as said thermally conductive coupling device a copper braided material.

7. The method of claim 1, wherein the providing step further comprises said writing device being formed with said writing elements formed in at least one row.

8. The method of claim 1, wherein the providing step further comprises said writing device being formed on a substrate attached to a temperature controlling mechanism.

9. The method of claim 8, wherein the controlling step further comprises controlling temperature in said substrate.

10. The method of claim 1, wherein the step of providing further comprises a centering element formed within said writing element.

11. The method of claim 10, wherein the measuring step further comprises measuring placement inaccuracies with respect to said centering element.

12. An array writer with length correction comprising:
a plurality of writing elements formed in a first direction within said array writer;
a temperature controlling device within said array writer; and
an interface to said temperature controlling device to allow for temperature control.

13. The array writer of claim 12, further comprising a lens being operatively configured to said plurality of writing elements.

14. The array writer of claim 13, further comprising at least one thermal coupling between said lens and said temperature controlling device.

15. The array writer of claim 14, wherein said thermal coupling is operative to transfer mechanical forces from said temperature controlling device to said array writer.

16. The array writer of claim 14, wherein said thermally conductive coupling device a copper braided material.

17. The array writer of claim 12, wherein said writing elements further comprise plural rows of said writing elements.

18. The array writer of claim 13, further comprising said writing elements being formed on a substrate having said lens attached to a first side of said substrate and said temperature controlling device attached to a second side of said substrate opposite said first side.

19. The array writer of claim 13, further comprising said writing elements being formed on a substrate having said temperature controlling device attached to a first side of said substrate with said lens attached to said temperature controlling device and a second side of said substrate opposite said first side being attached to a heatsink.

20. The array writer of claim 13, further comprising a centering device located in said array writer.
